(19) United States
(12) Patent Application Publication
(10) Pub. No.: US 2018/0244125 A1
(43) Pub. Date: Aug. 30, 2018

(54) TUBULAR SPRING FOR MOTOR VEHICLES, AND A METHOD FOR PRODUCING A TUBULAR SPRING

(71) Applicants: THYSSENKRUPP FEDERN UND STABILISATOREN GMBH, Hagen (DE); thyssenkrupp AG, Essen (DE)

(72) Inventors: Dieter LECHNER, Düsseldorf (DE); Timo STRAKA, Olpe (DE); Frank SCHNEIDER, Dortmund (DE)

(73) Assignees: THYSSENKRUPP FEDERN UND STABILISATOREN GMBH, Hagen (DE); thyssenkrupp AG, Essen (DE)

(21) Appl. No.: 15/754,516

(22) PCT Filed: Sep. 6, 2016
(86) PCT No.: PCT/EP2016/070924

§ 371 Date: Feb. 22, 2018

(30) Foreign Application Priority Data
Sep. 11, 2015 (DE) 10 2015 217 401.8

(51) Int. Cl. B60G 21/055; B60G 11/18; B60G 11/14; F16F 1/14; F16F 1/06; C21D 9/02; C21D 8/10

(52) U.S. Cl. CPC B60G 21/055; B21D 51/16; B60G 11/14; F16F 1/14; F16F 1/06; C21D 9/02; C21D 8/105; B60G 2206/724; B60G 2206/8103; B60G 2202/12; B60G 2202/13; B60G 2202/135; B60G 2206/427; B60G 2206/81035; B60G 2206/8402; F16F 2224/0208; F16F 2226/04; F16F 2228/007; F16F 2234/02; C21D 2211/008; B60G 11/18

(57) ABSTRACT

A tubular spring, such as a coil spring, a torsion-rod spring, and/or a stabilizer for a motor vehicle, may include at least one metal tube element having a tube internal cross section, a tube internal diameter, a tube external diameter, a tube internal wall, and a tube wall thickness. At least one metal foam may be disposed in the tube internal cross section of the at least one metal tube element of the tubular spring in at least one part-region. In particular, the metal foam may be connected in an at least partially materially integral manner to the tube internal wall of the metal tube element. The at least one metal tube element may have an at least partially martensitic structure.

The present invention relates to a tubular spring for motor vehicles and to a method for producing a tubular spring.

### PRIOR ART

Springs and torsion rods from formed steel tube or steel wire are known in the prior art in a multiplicity of embodiments. Torsion rods are also referred to as torsion-rod springs, stabilizer torsion rods, or torsion spring rods, for example. Steel springs and torsion-rod springs are used in particular in motor vehicles, wherein steel springs are used, for example, in spring/damping systems for absorbing road surface unevenness, and torsion-rod springs are used for stabilizing the rolling motion of a motor vehicle when negotiating a curve, the travel of a motor vehicle across changing road surfaces, and in the case of road surface unevenness. Such stabilizers are usually disposed in the region of the front axle and of the rear axle and in most instances extend across the entire width of the vehicle. The shaping of the steel tube or of the steel wire to springs and torsion rods can be performed according to forming methods that are known in the prior art. Prior to said shaping, or thereafter, the steel tube or the steel wire can be subjected to various preparation steps which influence the spring characteristics and strength characteristics and improve further specific use characteristics of a material. Springs and/or torsion rods having high strength values can thus be produced at a comparatively low investment in terms of material and thus with a low weight and material costs. Tubular springs herein, as compared to rod-type springs, have a lower weight at the same spring characteristics, the stiffness and flexural capability in the case of tubular stabilizers depending on the diameter and on the wall thickness. However, by virtue of a reduced flexural capability on account of the higher internal stresses caused during shaping and in the operation of the component, an increase of the diameter-to-wall thickness ratio in favor of a higher saving in terms of weight is only possible within limits. The characteristics of tubular springs are thus restricted to a narrow range in terms of geometric dimensions and of the spring characteristics resulting therefrom, or the forming capability of the steel tube or of the steel wire is limited in the case of some forming methods that are known in the prior art, respectively. In particular, the parameters of strength and tenacity are in correlation with the forming capability and the service life of a spring. Furthermore, rod-type springs, as opposed to tubular springs with the same geometric external dimensions, have a higher weight, on the one hand, while tubular springs require protection against corrosion on the tube internal surface, on the other hand, the latter being difficult to access, and said protection against corrosion requiring further method steps such as, for example, shot-blasting.

A method for producing hot-formed coil springs is known from DE 103 15 418 B3, for example.

A method for the thermal-mechanical treatment of steel for spring elements that are stressed in terms of torsion is described in DE 198 39 383 C2.

The present invention is therefore based on the object of providing an improved tubular spring, in particular an improved coil spring, torsion-rod spring, and/or a stabilizer for motor vehicles, and a method for producing a tubular spring, in which spring and method the aforementioned disadvantages are avoided. In particular, it is to be possible by way of this improved tubular spring and of the improved method for producing a tubular spring for the advantages of a spring that is produced from steel tube to be at least in part combined with the advantages of a spring that is produced from steel wire. Moreover, it is to be possible by way of the tubular spring according to the invention and the improved method for producing a tubular spring for a flexural capability that is improved in comparison to conventional tubular springs and methods to be provided, and for fissures that are caused by forming methods to be avoided. Furthermore, the requirement of a protection against corrosion of the tube internal surface is to be able to be dispensed with. Moreover, a stable manufacturing process which can be implemented in a simple and reliable manner in already existing methods is to be provided by way of the improved method for producing a tubular spring. Moreover, there is to be the potential for a geometrical moment of inertia that is predefined for various part-regions and/or diameters of the tubular spring to be able to be set in a targeted manner and also for said geometrical moment of inertia to be able to be set in a variable manner in the various part-regions and/or diameters.

### DISCLOSURE OF THE INVENTION

This object is achieved by a tubular spring according to claim 1 and by a method for producing a tubular spring that is foamed in at least one part-region, according to claim 6.

As compared to conventional tubular springs, the tubular spring according to the invention for motor vehicles has the advantage that the characteristics of a rod-type spring are at least in part combined with the properties of a tubular spring. In particular, forming actions which far exceed the flexural capability of conventional tubular springs are possible by way of the tubular spring according to the invention. Moreover, characteristics, in particular the stiffness and the flexural stiffness, can be established according to the requirements in each portion and/or region of the spring in the case of the tubular spring according to the invention. Furthermore, the stiffness characteristics and spring characteristics in the case of the tubular spring according to the invention can be set by way of the diameter-to-wall thickness ratio, while considering lightweight construction modes. Moreover, the tubular spring according to the invention does not require any protection against corrosion on the tube internal surface. It is furthermore possible for a multiplicity of different spring rates to be produced in the case of a predefined external tube diameter and/or of a predefined wall thickness.

As compared to conventional methods, the method according to the invention for producing a tubular spring that is foamed in at least one part-region has the advantage that a method step of providing a protection against corrosion of the tube internal surface can be dispensed with. Moreover, by way of the method according to the invention for producing a tubular spring that is foamed in at least one part-region an improved flexural capability of the tubular spring is provided, fissures that are caused by forming methods thus being largely avoided. It is a further advantage of the method according to the invention that said method can be integrated in a simple and reliable manner into already existing methods. Furthermore, the stiffness of the tubular spring along the length of the tubular spring can be set in a variable manner by way of the metal foam that is inserted into the respective part-region of the tubular spring and by way of the characteristics of said metal foam. A distribution of stress that is adapted under an operating load results therefrom.

The subject matter of the invention is therefore a tubular spring, in particular as a coil spring, torsion-rod spring, and/or stabilizer for motor vehicles, comprising at least one metal tube element having a tube internal cross section, a tube internal diameter, a tube external diameter, a tube internal wall, and a tube wall thickness, wherein at least one metal foam is disposed in the tube internal cross section of the at least one metal tube element of the tubular spring in at least one part-region, and the at least one metal tube element has an at least partially martensitic structure.

A further subject matter of the invention is a method for producing a tubular spring that is foamed in at least one part-region, in particular as a coil spring, torsion-rod spring, and/or stabilizer for motor vehicles, said method comprising the following steps:
a) providing at least one preliminary material composition comprising at least one metal component having a melting temperature, and a expanding agent component;
b) providing a tubular spring comprising at least one metal tube element having a tube internal cross section, a tube internal diameter, a tube external diameter, a tube internal wall, and a tube wall thickness;
c) inserting the at least one preliminary material composition as provided in step a) into the at least one metal tube element of the tubular spring as provided in step b), wherein the at least one metal tube element is filled completely or in part-regions;
d) tempering at least the at least one metal tube element as filled completely or in part-regions in step c), said tempering comprising
   i. heating the at least one metal tube element as filled completely or in part-regions in step c) at least to a hardening temperature, wherein the hardening temperature is a temperature above the minimum re-crystallization temperature of the metal tube element, preferably equal to or higher than the austenite start temperature of the metal tube element, and wherein the hardening temperature is equal to or higher than the melting temperature of the at least one preliminary material composition as inserted in step c), wherein the preliminary material composition foams while producing an at least one metal tube element that is foamed in at least one part-region;
   ii. quenching the at least one metal tube element that is filled completely or in part-regions and is in step i. heated at least to the hardening temperature to a first cooling temperature, wherein the first cooling temperature is a temperature below the minimum re-crystallization temperature of the metal tube element and an at least partially martensitic structure is set in the at least one metal tube element that is filled completely or in part-regions;
   iii. re-heating the at least one metal tube element that is filled completely or in part-regions as quenched in step ii. to a first tempering temperature which is lower than the austenite start temperature;
   iv. cooling the at least one metal tube element that is filled completely or in part-regions as re-heated in step iii. to a second cooling temperature, wherein the second cooling temperature is at least lower than the first tempering temperature,
      wherein an at least partially materially integral connection is configured at least in part-regions between the tube internal wall of the at least one metal tube element that is foamed in at least one part-region and the metal foam of the at least one metal tube element that is foamed in at least one part-region.

A further subject matter of the invention is the use of a tubular spring that is foamed in at least one part-region for suspension systems of vehicles, in particular motor vehicles.

### DETAILED DESCRIPTION OF THE INVENTION

In the context of the present invention, a tubular spring is understood to be a component comprising at least one metal tube element which yields under stress and after de-stressing returns to the original shape. In particular, a tubular spring can be a component that is wound in a screw-shaped or helical manner from steel tube, or a component that is elongated in a rod-shaped manner, or an angularly bent component. Examples of tubular springs are selected from a group comprising coil springs, in particular coil compression springs, coil tension springs, conical springs, extension springs, flexible springs, in particular helical springs, wound torsion springs, and combinations thereof.

In the context of the present invention a torsion-rod spring is understood to be a component comprising at least one metal tube element in which, in the case of fixed clamping at both ends, the fastened ends carry out a mutual pivoting movement about the torsion-rod spring axis. In particular, the mechanical stress takes place substantially by way of a torque that engages in a manner tangential to the torsion-rod spring axis. Torsion-rod springs are also understood to be, for example, a straight torsion rod, an angular torsion rod, a torsion spring, a stabilizer torsion rod, a stabilizer, a split stabilizer, and combinations thereof.

In the context of the present invention a metal foam is understood to be a foam which comprises at least one metal component and is foamed by way of at least one expanding agent component. In particular, the at least one metal component is selected from a group comprising aluminum alloys, in particular eutectic alloys of aluminum and silicon, AlCU, AlMn, AlSi, AlMg, AlMgSi, AlZn, titanium alloys, and combinations thereof. For example, the metal components can be provided in a preliminary material composition which has been pressed into a geometric shape in particular by extrusion. Examples of geometric shapes can be selected from a group comprising bars, rods, tubes, crucifix elements, and combinations thereof. In particular, the preliminary material composition provided can be inserted into a tubular spring as a bulk material. Examples of expanding agent components are compositions comprising at least one metal hydride, in particular selected from a group comprising stoichiometric metal hydrides of, for example, alkali metals and alkaline earth metals, high-polymer metal hydrides, complex metal hydrides, non-stoichiometric metal hydrides, and combinations thereof. Expanding agent components are in particular selected as titanium hydride and titanium dihydride.

In one preferred embodiment of the invention, the at least one metal foam that is disposed in the tube internal cross section of the at least one metal tube element of the tubular spring in at least one part-region is connected in an at least partially materially integral manner to the tube internal wall of the at least one metal tube element.

In one further embodiment of the invention, the tube external diameter in relation to the tube wall thickness of the at least one metal tube element has a ratio of more than 8, preferably of more than 12, particularly preferably of more than 20, most particularly preferably of more than 30.

According to one further potential embodiment of the invention, the at least one metal foam that is disposed in the tube internal cross section of the at least one metal tube element has a density of less than 1 g/cm³, preferably of less than 0.6 g/cm³, particularly preferably in a range from 0.1 to 0.5 g/cm³.

In one advantageous embodiment of the invention, the at least one metal tube element is at least partially formed so as to be a tubular spring that is configured so as to not be fully rectilinear.

The preliminary material composition has in particular been subjected to a shaping process, for example in an extruder, has been compacted, and has a basic structure that is suitable for conveying such that the insertion, in particular the filling of a tubular spring, can be carried out by way of a shear method.

The at least partially materially integral connection that is configured between the metal foam of the at least one metal tube element that is foamed in at least one part-region and the at least one metal tube element that is foamed in at least one part-region in the context of the invention is understood to be a non-releasable connection such as, for example, a welded connection, in particular a diffusion-welded connection. For example, the action of force, in particular the pressure on the internal shell face of the at least one foamed metal tube element, that, apart from a thermal input, is required for a diffusion-welded connection can be performed by the expansion pressure of the foaming metal foam.

The melting temperature is understood to be the temperature at which the at least one metal component melts, in particular transitions from the solid to the liquid aggregate state.

The minimum re-crystallization temperature is understood to be the lowest temperature at which a re-crystallization, in particular a re-crystallization of the structure of a steel wire, is still performed.

The re-crystallization temperature is that annealing temperature which in the case of a cold-formed structure having a pre-defined degree of forming leads to a complete re-crystallization in a limited timeframe. The re-crystallization temperature has no fixed value but depends on the degree of the preceding cold-forming and on the melting temperature of the material, in particular on the melting temperatures of steel types. For example, the re-crystallization temperature in the case of steel types also depends on the carbon content and on the alloy of the respective steel.

The austenite start temperature in the context of the invention is understood to be a temperature at which a conversion to an at least partially austenitic structure is performed. In particular, a conversion to an at least partially austenitic structure is performed at an austenizing temperature.

For example, the insertion in step c) of the at least one preliminary material composition as provided in step a) into the at least one metal tube element of the tubular spring as provided in step b) can be carried out by placing, stuffing, pouring, and by combinations thereof. A lance can be used as an inserting device, for example.

In one further embodiment of the invention, the at least one metal tube element as provided in step b) has at least in part a ferritic pearlitic structure.

In one preferred embodiment of the invention, the production of the tubular spring is carried out using a steel tube having a carbon content in the range from 0.02 to 0.8% by weight. In particular, in the context of the invention steel types having a carbon content in the range from 0.02 to 0.8% by weight are understood to be hypoeutectic steel types.

According to one further potential embodiment of the invention, the heating in step i. and/or the re-heating in step iii. of at least the at least one metal tube element that is filled completely or in part-regions is carried out by way of a heat transmission that is selected from a group comprising heat conduction, in particular a conductive heating, a thermal radiation, in particular an inductive heating, convection, and combinations thereof.

Heating as is performed, for example, in step i., in the case of re-heating in step iii. and/or another heat transmission in the context of the invention is understood to be such heating which is selected from a group comprising heat conduction, in particular a conductive heating, a thermal radiation, in particular an infrared radiation, an inductive heating, convection, in particular a heating blower, and combinations thereof.

In particular, a temperature that is higher than the melting temperature of the metal component, for example of higher than 620° C., is achieved in the heating. The re-heating is performed in particular at a temperature which is lower than the melting temperature of the metal component, for example is lower than 620° C.

In one further advantageous embodiment of the invention, the re-heating in step iii. of the at least one metal tube element that is filled completely or in part-regions and quenched as in step ii. is performed to a first tempering temperature which is lower than the melting temperature of the metal component.

A tempering in step d) in the context of the present invention can be a partial or complete tempering.

According to one further potential embodiment of the invention, forming of the at least one metal tube element as provided in step b), and/or the at least one metal tube element that is foamed in at least one part-region and tempered as in step d), so as to be a tubular spring that is configured so as to not be fully rectilinear and is foamed in at least one part-region is carried out in a further step e).

In one advantageous embodiment of the invention, forming in step e) is cold-forming and as a step is carried out at a cold-forming temperature in the sequence following the tempering in step d), wherein the cold-forming temperature is a temperature below the minimum re-crystallization temperature of the metal tube element, preferably lower than the austenite start temperature of the metal tube element.

Cold-forming in the context of the present invention is understood to take place when the steel tube is formed below the re-crystallization temperature. In particular, the shape-changing capability is limited in the case of cold-forming since the tenacity and forming capability of a material such as, for example, steel as a result of cold solidification decreases as the degree of forming increases. Examples of cold-forming are cold-coiling, cold-winding, cold-bending, and combinations thereof.

According to a further potential embodiment of the invention, forming in step e) is hot-forming and as a step is carried out at a hot-forming temperature in the sequence prior to the tempering in step d), wherein the hot-forming temperature is a temperature above the minimum re-crystallization temperature of the metal tube element, preferably equal to or higher than the austenite start temperature of the metal tube element. In particular, the hot-forming temperature is lower than the martensitic start temperature of the metal tube element and lower than the melting temperature of the preliminary material composition.

Hot-forming in the context of the present invention is understood to take place when the steel tube is formed above the re-crystallization temperature. In particular, the material such as, for example, steel re-crystallizes during or immediately after hot-forming, on account of which the material regains its original characteristics. For example, hot-forming is referred to as a forming-simultaneous re-crystallization of the material structure. Examples of hot-forming are hot-coiling, hot-bending, and combinations thereof.

In one advantageous embodiment of the invention, the heating in step i., and/or the re-heating in step iii., of at least the metal tube element that is filled completely or in part-regions is/are carried out at a heating velocity of at least 2 K/s, preferably of more than 20 K/s, particularly preferably of more than 50 K/s, most particularly preferably of more than 200 K/s.

In one preferred embodiment of the invention, in the foaming of the preliminary material composition in step i. a density of the metal foam that is foamed in the at least one metal tube element of less than 1 g/cm³, preferably of less than 0.6 g/cm³, particularly preferably in a range from 0.1 to 0.5 g/cm³ is set.

### BRIEF DESCRIPTION OF THE DRAWINGS

The tubular spring according to the invention will be explained by means of the drawings in which

FIG. 1 schematically shows variously formed tubular springs according to the prior art;

FIG. 2 schematically shows an oblique view of a metal tube element of a tubular spring according to the prior art; and

FIG. 3 schematically shows a cross section of a foamed metal tube element of a tubular spring according to embodiments of the invention.

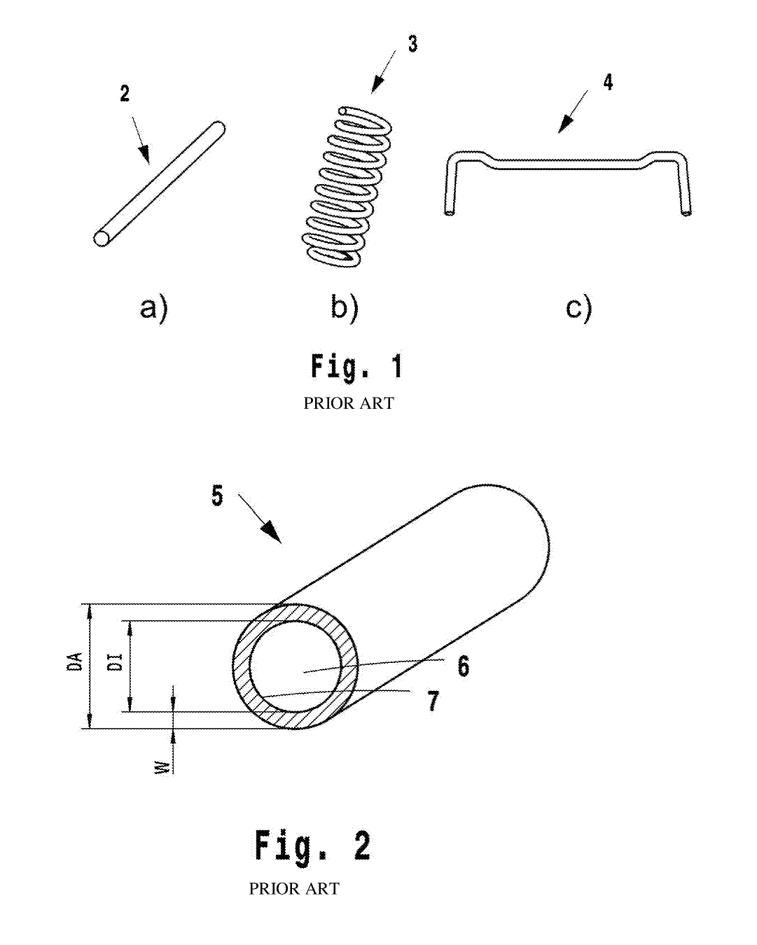

Variously formed tubular springs 1 according to the prior art are illustrated and marked a) to c) in FIG. 1. A torsion-rod spring 2 is illustrated as a). The marking b) illustrates a coil spring, and c) illustrates a stabilizer 4.

An oblique view of a metal tube element 5 of the tubular spring 1 according to the prior art is illustrated in FIG. 2. The metal tube element 5 has a tube internal cross section 6 having a tube internal diameter DI, a tube external diameter DA, a tube internal wall 7, and a tube wall thickness W. The tube internal cross section 6 is not foamed.

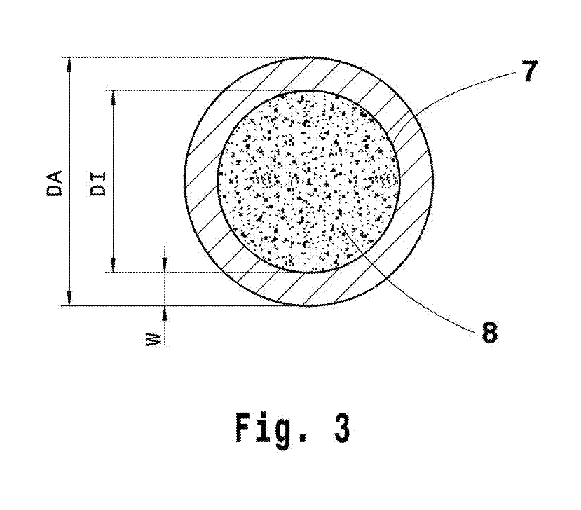

A cross section of the foamed metal tube element 5 of a tubular spring 1 according to one embodiment of the invention is schematically illustrated in FIG. 3. At least the metal foam 8 is disposed within the tube internal cross section 6 in at least one part-region. The metal tube element 5 according to the invention has the tube internal cross section 6 having the tube internal diameter DI, the tube external diameter DA, the tube internal wall 7 and the tube wall thickness W. The metal foam 8 is illustrated as a variable porous structure.

### INDUSTRIAL APPLICABILITY

Tubular springs, in particular as a coil spring, a torsion-rod spring, and/or a stabilizer of the type described above are used in the production of motor vehicles, in particular of suspension systems of the motor vehicles.

### LIST OF REFERENCE SIGNS

1=Tubular spring
2=Torsion-rod spring
3=Coil spring
4=Stabilizer
5=Metal tube element
6=Tube internal cross section
7=Tube internal wall
8=Metal foam
DA=Tube external diameter of the metal tube element
DI=Tube internal diameter of the metal tube element
W=Tube wall thickness

1.-12. (canceled)

13. A tubular spring comprising:
a metal tube element having a tube internal cross section, a tube internal diameter, a tube external diameter, a tube internal wall, and a tube wall thickness, wherein the metal tube element has an at least partially martensitic structure; and
a metal foam disposed in the tube internal cross section of the metal tube element of the tubular spring in at least one part-region.

14. The tubular spring of claim 13 configured as a torsion-rod spring.

15. The tubular spring of claim 13 configured as a coil spring.

16. The tubular spring of claim 13 configured as a stabilizer.

17. The tubular spring of claim 13 wherein the metal foam is connected in an at least partially materially integral manner to the tube internal wall of the metal tube element.

18. The tubular spring of claim 13 wherein a ratio of the tube external diameter relative to the tube wall thickness is more than 8.

19. The tubular spring of claim 13 wherein the metal foam has a density of less than 1 g/cm³.

20. The tubular spring of claim 13 wherein the metal tube is at least partially formed so as to be a tubular spring that is configured so as not to be fully rectilinear.

21. A method for producing a tubular spring that is foamed in at least one part-region, the method comprising:
providing a preliminary material composition comprising a metal component having a melting temperature, and an expanding agent component;
providing a tubular spring comprising a metal tube element having a tube internal cross section, a tube internal diameter, a tube external diameter, a tube internal wall, and a tube wall thickness;
inserting the preliminary material composition into the metal tube element of the tubular spring, wherein the metal tube element is filled completely or in the at least one part-region; and
tempering the metal tube element as filled completely or in the at least one part-region, wherein the tempering comprises
heating the metal tube element at least to a hardening temperature, wherein the hardening temperature is above a minimum re-crystallization temperature of the metal tube element, wherein the hardening temperature is equal to or higher than the melting temperature of the preliminary material composition, wherein the preliminary material composition foams while heating the metal tube element such that the metal tube element includes a metal foam in the at least one part-region,
quenching the metal tube element to a first cooling temperature that is below the minimum re-crystallization temperature of the metal tube element, wherein an at least partially martensitic structure is set in the metal tube element,
re-heating the metal tube element to a first tempering temperature that is lower than an austenite start temperature of the metal tube element, and
cooling the metal tube element to a second cooling temperature that is lower than the first tempering temperature,
so as to form an at least partially materially integral connection in the at least one part-region between the tube internal wall of the metal tube element and the metal foam of the metal tube element.

22. The method of claim 21 wherein the metal tube element that is provided includes a ferritic pearlitic structure, at least in part.

23. The method of claim 21 wherein at least one of the metal tube element that is provided before insertion of the preliminary material composition or the metal tube element that includes the metal foam and has been tempered is configured so as not to be fully rectilinear, the method further comprising forming the metal tube element in the at least one part-region.

24. The method of claim 23 wherein the forming of the metal tube element in the at least one part-region is cold-forming and is performed at a cold-forming temperature after the metal tube element is tempered, wherein the cold-forming temperature is below the minimum re-crystallization temperature of the metal tube element.

25. The method of claim 23 wherein the forming of the metal tube element in the at least one part-region is cold-forming and is performed at a cold-forming temperature after the metal tube element is tempered, wherein the cold-forming temperature is below the austenite start temperature of the metal tube element.

26. The method of claim 23 wherein the forming of the metal tube element in the at least one part-region is hot-forming and is performed at a hot-forming temperature prior to the tempering of the metal tube element, wherein the hot-forming temperature is above the minimum re-crystallization temperature of the metal tube element.

27. The method of claim 23 wherein the forming of the metal tube element in the at least one part-region is hot-forming and is performed at a hot-forming temperature prior to the tempering of the metal tube element, wherein the hot-forming temperature is above the austenite start temperature of the metal tube element.

28. The method of claim 21 wherein a density of the metal foam in the metal tube element is less than 1 g/cm³.

29. The method of claim 21 wherein a density of the metal foam in the metal tube element is less than 0.6 g/cm³.

30. The method of claim 21 wherein a density of the metal foam in the metal tube element is in a range from 0.1 to 0.5 g/cm³.
